(19) United States
(12) Patent Application Publication
(10) Pub. No.: US 2007/0266095 A1
(43) Pub. Date: Nov. 15, 2007

(54) SEAMLESS ELECTRONIC MAIL CAPTURE WITH USER AWARENESS AND CONSENT

(75) Inventors: Daniel Billsus, San Francisco, CA (US); David M. Hilbert, Palo Alto, CA (US)

Correspondence Address: FLIESLER MEYER LLP, 650 CALIFORNIA STREET, 14TH FLOOR, SAN FRANCISCO, CA, 94108, US

(73) Assignee: FUJI XEROX CO., LTD., Tokyo (JP)

(21) Appl. No.: 11/620,850

(22) Filed: Jan. 8, 2007

Related U.S. Application Data
(60) Provisional application No. 60/799,820, filed on May 12, 2006.

(51) Int. Cl. G06F 15/16

(52) U.S. Cl. 709/204

(57) ABSTRACT

The present invention provides employees and/or associates the opportunity to share corporate knowledge via the storage of electronic message (email) with user awareness and consent features. In various embodiments of the invention, awareness and consent over email sharing is provided via automated message modification and message generation. In one embodiment of the invention, the granted sharing permissions are communicated to all original message recipients and authors to enhance awareness of sharing decisions made by individual employees. All employees who are allowed to access the shared content according to the sharing privileges can subsequently find or discover content via full-text searches or other means, such as content-based recommendations.

### PRIORITY CLAIM

This application claims priority under 35 U.S.C. 119(e) to U.S. Provisional Application No. 60/799,820, filed May 12, 2006, entitled SEAMLESS ELECTRONIC MAIL CAPTURE WITH USER AWARENESS AND CONSENT, which application is incorporated herein by reference.

### FIELD OF THE INVENTION

This invention involves intercepting electronic messages to allow a copy to be stored and shared within an employment group or other association to allow access to shared content, embedded links and attached files via full-text searches or just-in-time recommendations.

### BACKGROUND OF THE INVENTION

Employees of any organization commonly exchange valuable information via electronic mail (email). For example, employees may discuss ideas, ask and answer questions, comment on corporate activities, or share and discuss documents. The vast majority of these messages are sent to individuals or small groups of recipients.

A short recipient list does not necessarily mean that the message contains confidential information that cannot be shared with others. For example, email authors may decide to send information only to their teammates, select recipients based on an assessment of how immediately relevant the content may be to the recipient, the likelihood of getting an answer to a question from a presumed expert, or simply the degree of familiarity with a recipient. Similarly, potential recipients may be excluded from messages simply because the sender does not want to bother people who, presumably, may not be immediately interested.

Depending on corporate email archiving policies, the complete email corpus of an organization is sometimes accessible to executives and administrators (for accountability reasons and litigation support). However, for privacy reasons, making email globally accessible or searchable is clearly not a viable approach to corporate knowledge sharing.

### SUMMARY OF THE INVENTION

In various embodiments of the invention, methods of seamless electronic mail capture with user awareness and consent allow a group of employees and/or associates to engage in knowledge sharing via email. In an embodiment of the invention, storage and access of stored emails including automated sharing advice, notifications and replies based on content, can facilitate email sharing. It is noted, that the term ‘based on’ as used herein, means ‘based at least in part on’, unless otherwise specified. In an embodiment of the invention, the email sharing is carried out by allowing users to express email-sharing permissions, which are subsequently used to share email content on-demand. In a further embodiment of the invention, the granted permissions are communicated to all original message recipients and authors to enhance awareness of sharing decisions made by individual employees. In an embodiment of the invention, this is accomplished through email author's express sharing permissions via labeling messages before they are sent. In an embodiment of the invention, the email server intercepts labeled messages before they reach any recipients. In an embodiment of the invention, the email server modifies the body of the message to indicate the sharing activity to all recipients and provides recipients with a means for modifying the shared content or associated access privileges. In an embodiment of the invention, the proposed system stores and indexes the shared message, along with embedded and linked content. In an embodiment of the invention, all employees who are allowed to access the shared content according to the sharing privileges can subsequently find or discover content.

This summary is not intended to be a complete description of, or limit the scope of the invention. Alternative and additional features, aspects, and objects of the invention can be obtained from a review of the specification, the figures, and the claims.

### BRIEF DESCRIPTION OF THE FIGURES

Preferred embodiments of the present invention will be described in detail based on the following figures, wherein:

FIG. 1 illustrates a non-confidential email message;

FIG. 2 illustrates a non-confidential email message including ‘linked’ content;

FIG. 3 illustrates an intercepted and modified email message;

FIG. 4 illustrates a sharing notification email message;

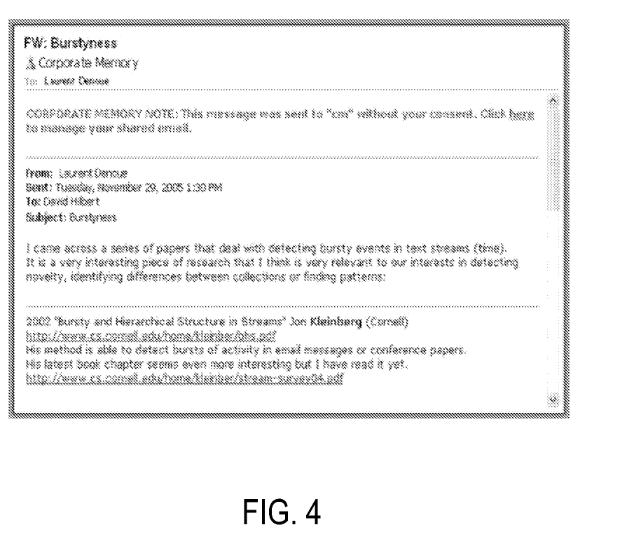

FIG. 5 illustrates a tagged email message, where the author communicates a private message to a single recipient, and designates a part of the same message as accessible by the sales team;

FIG. 6 illustrates an interactive search scenario, where text from the email message associated with the matched document provides additional context;

FIG. 7 illustrates that an email header text can be used to identify the original sender of a message; and

FIG. 8 illustrates an example of a proactive recommendation embodiment of the invention.

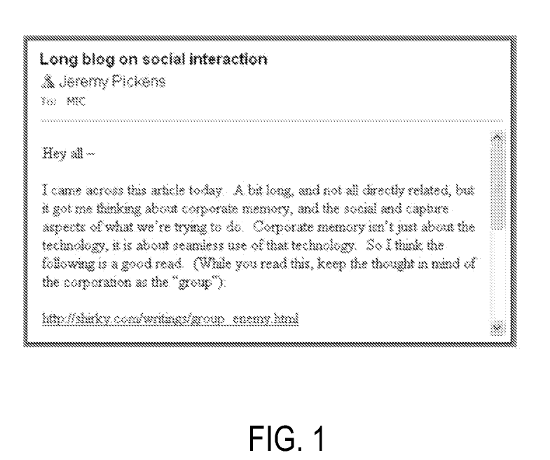

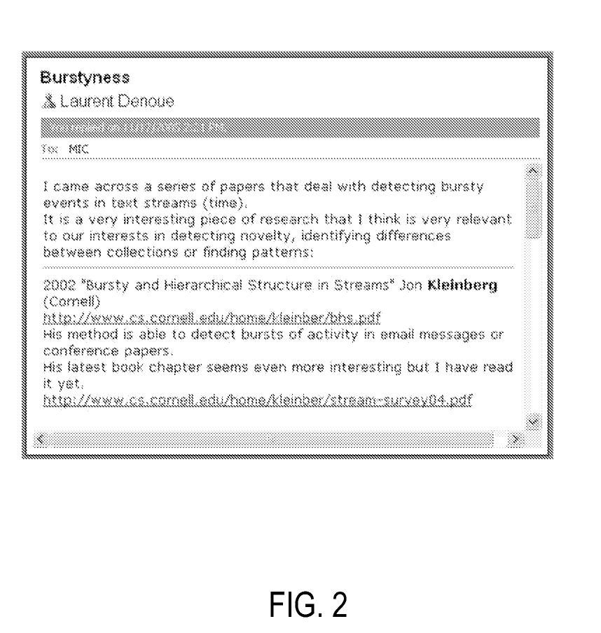

Clearly, no email sender can accurately predict who may have a need for the communicated information at any point in time: employees' projects and interests change over time, new employees may join the organization, and separate corporate branches may not be familiar enough with each others' activities and interests to actively share information. As a result, information and content communicated via email is often not effectively utilized. Employees who were not on an original list of recipients have no way to search for or discover the communicated information. FIG. 1 and FIG. 2 show messages sent to a small group that contain non-confidential information that could be useful to others in the organization.

In an embodiment of the invention, this invention allows organizations to better utilize email content without infringing on established email practices, or sacrificing employees' privacy and control over shared content. In an embodiment of the invention, express email-sharing permissions, are used to share content on-demand. In an embodiment of the invention, the granted permissions are communicated to all original email recipients and authors to enhance awareness of sharing decisions made by individual employees.

The following paragraphs provide a brief overview of 4 main components that make up various embodiments of the invention: sharing designation, sharing notification, content processing and content retrieval.

### Sharing Designation

In an embodiment of the invention, email authors can easily indicate which email messages they would like to share and with whom, with little additional effort.

### Sharing Notification

In an embodiment of the invention, sharing notifications increase a users' awareness of other employees' sharing decisions and provide authors with opportunities to control the sharing of their content.

### Content Processing

In an embodiment of the invention, the proposed system stores and indexes shared messages, along with all associated embedded and linked content.

### Content Retrieval.

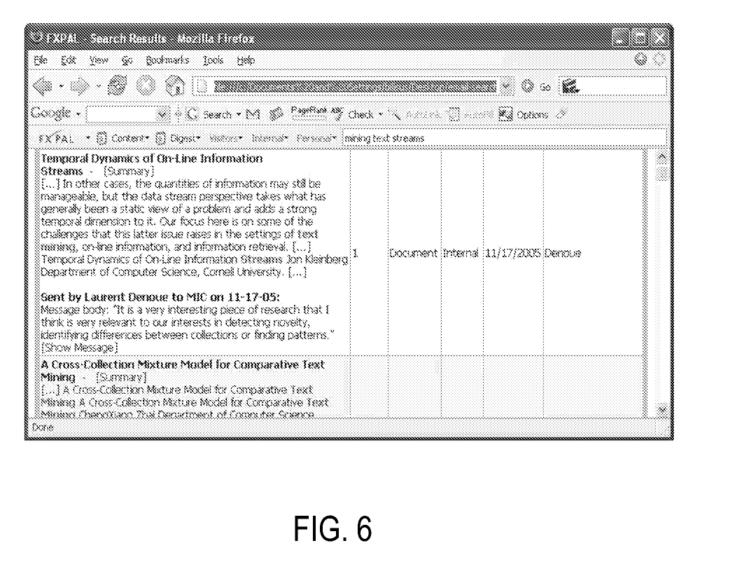

In an embodiment of the invention, all employees who are allowed to access shared email content according to user specified sharing privileges can subsequently find or discover content via full-text searches, just in-time recommendations or other content access mechanisms. FIG. 6 shows an example search result page that includes a document that was linked in the email message shown in FIG. 2. The text of the message is visible as part of the search result, providing potentially useful context.

### DETAILED DESCRIPTION OF THE INVENTION

### Technical Details

In this section, various exemplary email-sharing solutions that can form the basis for various embodiments of the invention are described.

### Sharing Designation

In an embodiment of the invention, assigning access rights to email messages before they are sent can be accomplished in various ways. The goal of this step is to allow authors to explicitly assign privileges in a way that does not cause significant usage overhead and does not interfere with established email practices. A convenient and near-seamless way to label messages is to ‘carbon copy’ (CC) a virtual email address that represents the group of employees allowed to access the message. For example, CC'ing an account named ‘Corporate Memory’ (CM) may allow employees to assign company-wide access privileges to the message with only two extra keystrokes.

In another embodiment of the invention, a related approach consists of modifying existing email addresses or distribution lists with a pre-defined modifier to express fine-grained access rights without requiring users to memorize artificial email accounts. For example, consider an email setup where the distribution list ‘sales’ includes the email addresses of the organization's 10 sales people. If a user wanted to email a document to a single recipient, but at the same time express that the sales group may access the message if needed, this can be expressed by designating the individual user as the sole recipient and CC'ing the message to ‘CM-sales’. In this example, the system automatically identifies all addresses starting with ‘CM-’ as sharing designations, and is able to resolve the exact list of authorized employees based on the existing distribution list ‘sales’.

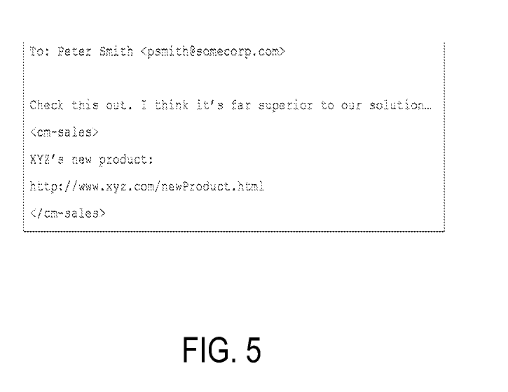

In another embodiment of the invention, express access privileges are used as tags in the body of the email message. While this approach slightly diverges from established email practices, it can potentially support more fine-grained access privileges, because authors do not have to share the entire message. Instead, portions of a message can be tagged as shared, possibly using tags based on existing email accounts as in the previous example. FIG. 5 shows an example of a message that is partially accessible by the sales team.

### Sharing Notification

An embodiment of this invention explicitly supports user consent and awareness. Since a system is envisaged that supports near-seamless sharing of content, it is particularly important to support explicit notification and control mechanisms, whereby authors can retain control over their content, even if it was shared by others. The proposed system supports at least two different forms of sharing notifications: message modification and message generation. These two forms of notification are briefly outlined.

### Message Modification

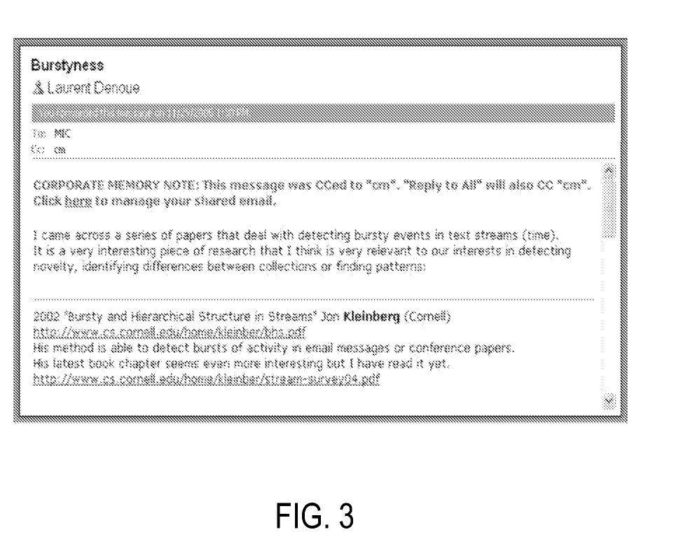

In an embodiment of the invention, message modification based on email interception furthers the general goal of supporting established email practices without burdening the user with extra overhead. As discussed above, assigning access rights via email addresses is convenient, but not necessarily obvious and transparent enough for all parties involved. For example, a user who replies to a message that was CC'ed to a shared email address may not fully understand that the resulting message will be accessible by a potentially large group of people. Likewise, the shared email address may be part of a distribution list and not immediately visible to the user. To increase awareness of implicitly designated access rights, the proposed system intercepts and modifies all messages that are sent to shared email addresses. For example, the system may modify the subject and/or body of the message to clearly indicate that the message is accessible to a wider group of people than the immediate recipients. Since the system intercepts and modifies messages before recipients receive them, this approach does not generate any extra message traffic or overhead for the user. FIG. 3 shows an example of an intercepted and modified message.

The modification may include one or more of the following:

an indication of the messages shared status

an indication of the users or user groups allowed to access the message

an indication of the resulting status of a ‘Reply to All’

the ability to view, edit or modify the shared content or associated access privileges.

A ‘Reply to All’ command of a communication typically sent by a receiving party is sent to the sender and all parties CC'd by the sender and in some cases parties listed as BCC by the sender. This invention, by extending the classes of persons who can access a communication will also raise the question of who will be able to access communications generated by a ‘Reply to All’ command. By indicating the status or effective receivers of a ‘Reply to All’ command, users can edit a receiving list. The invention can also provide users with a means for replying to all email recipients without CC'ing the shared email address which would otherwise store the reply.

The modification can for example be accomplished via a hyperlink that takes the user to a message management web interface. Whether editing capabilities are available to authors and recipients or only to authors who contributed content to an email thread is a configuration detail.

The communication content is defined as the text of the communication and the links and files attached to the communication. Thus the text of a linked site referred to in a communication is part of the content of that communication.

Technically, message interception can be implemented on the client or server side. On the client side, the implementation may involve a plug-in for an email client. For example, popular email clients such as Microsoft Outlook or Mozilla Thunderbird support plug-in architectures for 3rd party extensions. In this case, the plug-in can modify the message just before the client sends it to the specified mail server. Alternatively, email interception can be implemented on the server side. The advantage of this approach is that no software is required on the client side, i.e. any email client can be used without any modifications. In this case, the message can be intercepted and modified before it reaches the organization's main email server (e.g. MS Exchange or a similar server product). Since email conforms to a standardized protocol (SMTP), this approach does not pose any technical challenges. Alternatively, the modification can be implemented as an integrated component of the organization's email server. Many mail servers (e.g. MS Exchange) support an open API for custom modifications.

### Message Generation

An embodiment of the invention, in addition to message interception and modification includes notification mechanisms designed to communicate sharing decisions that were made without explicit consent of the author. For example, someone may decide to forward someone else's message or an entire email thread to a designated ‘shared’ email address without including the author as a message recipient. In this case, the system can generate a new message to notify the author that content was shared and optionally provide the ability to edit or remove the shared content or associated access privileges. ‘Error! Reference source not found.’ shows an example of a sharing notification email.

An example of a message that would be generated when explicit consent was required and not given can be ‘Figure 9 Error! Reference source not found’.

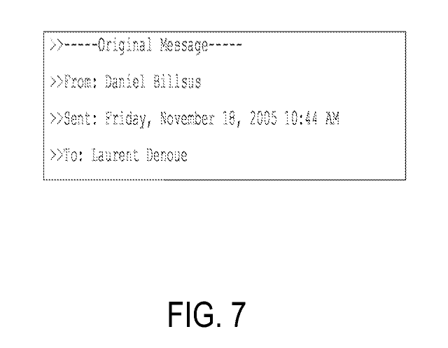

In an embodiment of the invention, the system analyses the shared email text to decide whom to notify. Using the default settings of most email clients typically leads to email threads that are included in their entirety in every single message. This means that the system can scan the text of a message for patterns that indicate email headers and sender information. For example a pattern like the one shown in FIG. 7 allows the system to identify the original sender of a message with reasonable accuracy. In an alternative embodiment of the invention, if the system has access to all messages of the organization on the mail server, the system does not have to rely on header matching techniques and can use the organization's email history to identify the original author of a message.

In an embodiment of the invention, the system can be configured to send sharing notifications immediately, i.e. as soon as someone shares someone else's content without their knowledge, or delayed at specified time intervals. A potential advantage of delayed sharing notifications is that the system can generate a list of all the content that was shared during a time interval, leading to fewer messages sent to the user. For example, the system can send a weekly message to an author, listing all email content that was shared during the week and providing the ability to view messages or change access rights.

### Content Processing

In an embodiment of the invention, the proposed system stores and indexes shared messages, along with embedded and linked content. This means that, in addition to the full text of the message subject and body, the system separately indexes attached files (e.g. Word or PDF files), and also downloads, stores and indexes linked web pages and documents. To process linked content, the system scans the body of the message for URLs. Since embedded URLs conform to standardized patterns consisting of host names, domain names, top-level domain names and file names, it is not difficult to identify all hyperlinks in an email message, even if they are not embedded within anchor tags ‘<a></a>’ or start with a protocol identifier (such as ‘http:/P’). For example, standard text-matching techniques, such as regular expressions, can be used to identify http://www.core.com/papers/whitepaper.pdf as a URL. The system downloads all linked documents and uses text extraction tools to extract the text of common file formats (e.g. Word, PowerPoint, PDF, etc.) to add the document to a searchable full-text index. Both text extraction and full-text indexing are commonly known techniques used by search engines. The system also retains information about the origin of indexed documents, i.e. an attached or linked document can always be traced back to a particular email message. The retrieval component of the proposed system can take advantage of these document associations as described below.

### Content Retrieval

In an embodiment of the invention, the proposed system stores shared messages and associated content for the purpose of subsequent retrieval or discovery by employees who were granted access via any of the access designation methods discussed above. In various embodiment of the invention, retrieval or discovery can be implemented in alternative ways. For example, the system can provide access to shared messages via interactive search, proactive recommendations or a web-based interface for message browsing. For all of these access alternatives, the system authenticates the user to ensure that employees only get access to the set of messages they are allowed to access. Authentication can be implemented via explicit account log-ins or authentication built into the operating system (e.g. using the Microsoft Windows account the user is currently logged into to establish the user's identity).

In an embodiment of the invention, the interactive search approach is based on standard full-text search techniques. Users can search for corporate email and associated resources via a dedicated search interface, or as part of a corporate search engine that, among other corporate resources, includes email content. Since the system retains information about the source of emailed documents, the search result interface can optionally display the text of the original message (as shown in FIG. 3). In addition, the search interface may provide access to the complete original message, as well as other documents included in the same message. This means that potentially useful content, e.g. an employee's comment that was included in the original email message, can be retrieved without any textual matches in the message itself.

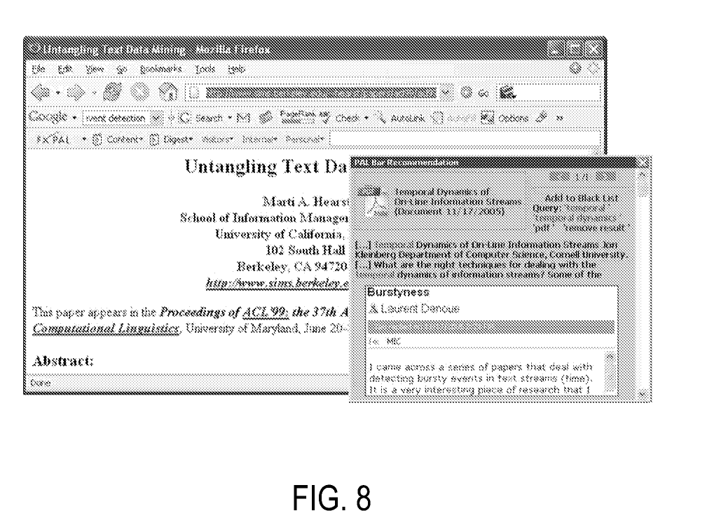

In an embodiment of the invention, the proactive recommendation approach utilizes contextual information to automatically present content related to the user's current context (e.g. the currently displayed document or web page). In an embodiment of the invention, contextual recommenders typically operate as follows. First, the system extracts textual information currently displayed on the user's screen. This can be accomplished via plug-ins for commonly used applications, such as web browsers, email clients or word processors. The extracted text is then used to retrieve related content, such as related email messages and attached or linked documents. This step of the process is often based on statistical text processing: using statistical term-weighting techniques (Van Rijsbergen, C. J. (1979). Information Retrieval. London: Butterworths) to identify informative terms, the text can be used to automatically construct a query which can subsequently be sent to a search engine to retrieve related content. Watson (Budzik, J., Hammond K., and Birnbaum, L. (2001). Information Access in Context. Knowledge-Based Systems 14 (1-2), pp 37-53, Elsevier Science) and FXPAL's ‘PAL Bar’ (Billsus, D., Hilbert D. M., and Maynes-Aminzade, D. (2005). Improving Proactive Information Systems. Proceedings of the 10th international conference on Intelligent user interfaces, IUI 2005, ACM) are examples of this type of system. FIG. 8 shows an example of a proactive recommendation embodiment. In this example, the user is looking at a web page about text mining. Using fully automated query generation techniques (Billsus, D., Hilbert D. M., and Maynes-Aminzade, D. (2005). Improving Proactive Information Systems. Proceedings of the 10th international conference on Intelligent user interfaces, IUI 2005, ACM), the ‘PAL Bar’ system can find closely related content. Here, PAL Bar automatically recommends a document that was originally included in the email message shown in FIG. 2. Similar to the explicit search scenario, the recommendation interface shown in FIG. 2 provides access to the matching document as well as the original message that contained the document. Similarly, the interface can provide access to other documents that were sent as part of the same message (because they are presumably related in some way, even if this cannot be established via content analysis). In the context of this invention, the proactive recommendation scenario is compelling, because it adds a seamless content discovery component to the proposed ‘near-seamless’ email capture techniques. The combined technologies result in a system that, with very minimal user effort, enables a powerful end-to-end solution for corporate knowledge sharing.

### System Extensions

In various embodiments of the invention, optional system extensions designed to improve the system's information sharing capabilities are described. FIG. 8 illustrates proactive document recommendation. The recommendation interface provides access to the matching document as well as the original message that contained a link to the document.

### Sharing Advice

In an embodiment of the invention, the sharing designation techniques described above depend on explicit user participation: a manual designation is always required to share messages. Even though the user overhead for sharing messages is minimal, it is likely that employees will forget to share non-confidential messages. In an embodiment of the invention, the system can provide automated sharing advice, reminding the user to share a message if its content seems appropriate for a group of recipients (or the entire organization). Using techniques to find closely related documents (similar to the techniques described in (Billsus, D., Hilbert D. M., and Maynes-Aminzade, D. (2005). Improving Proactive Information Systems. Proceedings of the 10th international conference on Intelligent user interfaces, IUI 2005, ACM), the system can automatically determine if a message is likely to be related to content that is already part of a shared repository. If the user did not share the message, the system can ask the user for permission to share the message with a group of appropriate recipients. This approach can be implemented on the client side (possibly via a plug-in for email clients as described above) or the server side (assuming that the system has access to all corporate email and not just shared messages). Sharing advice may be sent in the form of an email message or a client-side indicator (e.g., a ‘share-o-meter’ widget) that suggests that the message be shared. In various embodiments of the invention, the system can provide sharing advice in real-time, i.e. as a message is being composed, being sent, or just after it has been sent, or alternatively, in the form of a periodic email message that lists all messages sent during a specific time-frame that may be appropriate candidates for corporate knowledge sharing.

### Recommendations via Email Replies.

In an embodiment of the invention, the proposed system may optionally reply to messages sent to shared email addresses, notifying the sender and/or recipients of related corporate content (such as previous email discussions, related documents, etc). This feature is closely related to the proactive recommendation approach described above, i.e. it is designed to help users discover content related to their current activities or interests, and the same content matching algorithms can be used to implement this feature. The proactive recommendation approach described above requires a client-side tool that observes the user's current context to recommend closely related content. In contrast, the email reply approach does not require any client-side software and works with any email client.

The foregoing description of various embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

Various embodiments of the invention may be implemented using a processor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits and/or by interconnecting an appropriate network of component circuits, as will be readily apparent to those skilled in the art.

Various embodiments include a computer program product which can be a storage medium (media) having instructions and/or information stored thereon/in which can be used to program a general purpose or specialized computing processor(s)/device(s) to perform any of the features presented herein. The storage medium can include, but is not limited to, one or more of the following: any type of physical media including floppy disks, optical discs, DVDs, CD-ROMs, micro drives, magneto-optical disks, holographic storage devices, ROMs, RAMs, EPROMs, EEPROMs, DRAMs, PRAMS, VRAMs, flash memory devices, magnetic or optical cards, nano-systems (including molecular memory ICs); paper or paper-based media; and any type of media or device suitable for storing instructions and/or information. Various embodiments include a computer program product that can be transmitted in whole or in parts and over one or more public and/or private networks wherein the transmission includes instructions and/or information, which can be used by one or more processors to perform any of the features, presented herein. In various embodiments, the transmission may include a plurality of separate transmissions.

Stored on one or more computer readable media, the present disclosure includes software for controlling the hardware of the processor(s), and for enabling the computer(s) and/or processor(s) to interact with a human user or other device utilizing the results of the present invention. Such software may include, but is not limited to, device drivers, interface drivers, operating systems, execution environments/containers, user interfaces and applications.

The execution of code can be direct or indirect. The code can include compiled, interpreted and other types of languages. Unless otherwise limited by claim language, the execution and/or transmission of code and/or code segments for a function can include invocations or calls to other software or devices, local or remote, to do the function. The invocations or calls can include invocations or calls to library modules, device drivers, interface drivers and remote software to do the function. The invocations or calls can include invocations or calls in distributed and client/server systems.

The term ‘explicit indication’ includes text in a modified email message, text in a separate email message, a tool-tip, a pop-up dialog, a web page, a voice message and a file containing a message. The ‘explicit indication’ can be a phrase such as “This message has been saved to the corporate memory and is accessible to everyone in Sales and Marketing”. The term ‘author’ includes all entities designated in the “From:” field in an email or other electronic communication. The term recipient includes all entities in the “To:”, “Cc:” or “Bcc:” field in an email or other electronic communication. The term ‘participant’ includes all authors and recipients. The term ‘contributor’ refers to all authors who have contributed content to an email or electronic communication, but who are not necessarily ‘participants’. For example, if A sends a message to B, and B forwards the message to C, then B and C are ‘participants’ in the final message, but A is only a ‘contributor’. The term ‘participant and contributor’ includes entities A, B and C. The term ‘user’ refers to people who can access a stored copy of the communication, but who are not necessarily ‘participants’. A user can be a member of an organization to which the ‘participants’ belong. The ‘user group’ refers to a collection of ‘users’ who can access the stored copy of the communication, but who are not necessarily ‘participants’. For example, the “Sales group” of an organization may be a user group. The term ‘content’ of an electronic message includes text, embedded links and files attached to the electronic message. The term ‘analyze’ includes any means of ascertaining the one or more groups of users who have been designated as such in the email or electronic communication. The term ‘reply’ includes a reply to any and all participants, and specifically includes a ‘reply to all’ function in an email or electronic communication. The term ‘access’ includes inspecting text that a participant can read directly in the header or body of an email or electronic communication and content of the email or electronic communication, such as text in an embedded link and text in an attached file. In gaining ‘access’ a participant can perform a function such as clicking on a link or pressing a button. The term ‘stored copy’ of an electronic communication refers to a virtual replica of the information available to the recipients of the electronic communication which is stored. The term ‘notification’ can refer to a second electronic communication which is sent to notify ‘participants’ or ‘contributors’ of a first electronic communication.

In an embodiment of the invention, a method of indicating to participant(s) of an electronic communication that a copy of the electronic communication is being stored comprises analyzing the electronic communication to determine designated group(s) of user(s), storing a copy of the electronic communication onto a storage device, wherein the stored copy is available to the designated group(s) of user(s) and automatically modifying the electronic communication, wherein the modification indicates to the participant(s) that the copy of the electronic communication is stored. The stored copy can include content retrieved from link(s) embedded in the electronic communication and file(s) attached to the electronic communication.

In an alternative embodiment of the invention, the modification further comprises an explicit indication that executing a reply operation will result in the reply also being stored. The modification can further allow participant(s) to execute a reply operation without the reply also being stored.

In an embodiment of the invention, the modification further comprises a list of designated group(s) of user(s) that can access the stored copy of the electronic communication. The participant(s) can modify the designated group(s) of user(s) and/or the content of the stored copy of the electronic communication. The participant(s) can delete the stored copy of the electronic communication.

An alternative embodiment of the invention further comprises allowing participant(s) to access a list of previously stored electronic communication(s) in which the participant(s) was also a participant. In an embodiment of the invention, participant(s) can modify the designated group(s) of user(s) and/or the content of previously stored electronic communication(s) in which the participant was also a participant. Participant(s) can delete the content of previously stored electronic communication(s) in which the participant was also a participant. An embodiment of the invention further comprises allowing participant(s) to access a list of previously stored electronic communication(s) which are retrieved with a content search based on the content of the first electronic communication. In an alternative embodiment of the invention, a second electronic communication is sent to participant(s), wherein the second electronic communication contains a list of previously stored electronic communication(s) which are retrieved with a content search based on the content of the first electronic communication.

In another embodiment of the invention, a method of indicating to participant(s) and/or contributor(s) that an electronic communication is being stored comprises analyzing the electronic communication to determine designated group(s) of user(s), storing a copy of the electronic communication onto a storage device, wherein the stored copy is available to the designated group(s) of user(s), automatically analyzing the electronic communication to identify participant(s) and/or contributor(s) and automatically notifying the identified participant(s) and/or contributor(s) that a copy of the electronic communication is being stored. The notification can be an electronic communication to the participant(s) and/or contributor(s). The stored copy can include content retrieved from link(s) embedded in the electronic communication and files attached to the electronic communication.

In an embodiment of the invention, the notification further comprises allowing identified participant(s) and/or contributor(s) to access a list of the designated group(s) of user(s) that can access the stored copy of the electronic communication. Identified participant(s) and/or contributor(s) can modify the designated group(s) of user(s) and/or content of the stored copy of the electronic communication. Identified participant(s) and/or contributor(s) can delete the stored copy of the electronic communication.

In another embodiment of the invention, the notification further comprises allowing identified participant(s) and/or contributor(s) to access a list of previously stored electronic communication(s) in which the identified participant(s) and/or contributor(s) were also participant(s) and/or contributor(s). The notification can allow identified participant(s) and/or contributor(s) to modify identified designated group(s) of user(s) and/or content of previously stored electronic communication(s) in which the identified participant(s) and/or contributor(s) was also a participant or contributor. The notification can allow identified participant(s) and/or contributor(s) to delete content of previously stored electronic communication(s) in which the identified participant(s) and/or contributor(s) was also a participant or contributor. In an alternative embodiment of the invention, the notification further comprises allowing identified participant(s) and/or contributor(s) to access a list of previously stored electronic communication(s) which are retrieved with a content search based on content of the electronic communication.

In an embodiment of the invention, a method of storing an electronic communication and notifying identified participant(s) and/or contributor(s) of the electronic communication of the storage comprises automatically sending a notification, wherein the notification indicate to the identified participant(s) and/or contributor(s) that a copy of the electronic communication is being stored and storing the electronic communications including, storing content of the electronic communication, storing content of link(s) embedded in the content of the electronic communication and storing content of file(s) attached to the electronic communication.

Example embodiments of the methods, systems, and components of the present invention have been described herein. As noted elsewhere, these example embodiments have been described for illustrative purposes only, and are not limiting. Other embodiments are possible and are covered by the invention. Such embodiments will be apparent to persons skilled in the relevant art(s) based on the teachings contained herein. Thus, the breadth and scope of the present invention should not be limited by any of the above-described exemplary embodiments, but should be defined only in accordance with the following claims and their equivalents.

What is claimed is:

1. A method of indicating to one or more participant of an electronic communication that a copy of the electronic communication is being stored comprising:
(a) analyzing the electronic communication to determine one or more designated groups of users;
(b) storing a copy of the electronic communication onto a storage device, wherein the stored copy is available to the one or more designated groups of users; and
(c) automatically modifying the electronic communication, wherein the modification indicates to the one or more participant that the copy of the electronic communication is stored.

2. The method of claim 1, wherein the modification further comprises an explicit indication that executing a reply operation will result in the reply also being stored.

3. The method of claim 1, wherein the modification further allows one or more participant to execute a reply operation without the reply also being stored.

4. The method of claim 1, wherein the modification further comprises a list of one or more designated groups of users that can access the stored copy of the electronic communication.

5. The method of claim 1, wherein one or more participant can modify one or both the designated groups of users and the content of the stored copy of the electronic communication.

6. The method of claim 1, wherein one or more participant can delete the stored copy of the electronic communication.

7. The method of claim 1, wherein the stored copy includes content retrieved from one or more links embedded in the electronic communication.

8. The method of claim 1, wherein the stored copy includes one or more files attached to the electronic communication.

9. The method of claim 1, further comprises allowing one or more participant to access a list of one or more previously stored electronic communication in which the one or more participant was also a participant.

10. The method of claim 1, wherein one or more participant can modify one or both the one or more designated groups of users and the content of one or more previously stored electronic communication in which the participant was also a participant.

11. The method of claim 1, wherein one or more participant can delete the content of one or more previously stored electronic communication in which the participant was also a participant.

12. The method of claim 1, further comprises allowing one or more participant to access a list of one or more previously stored electronic communication which are retrieved with a content search based on the content of the first electronic communication.

13. The method of claim 1, wherein a second electronic communication is sent to one or more participants, wherein the second electronic communication contains a list of one or more previously stored electronic communication which are retrieved with a content search based on the content of the first electronic communication.

14. A method of indicating to one or both of one or more participant and one or more contributor that an electronic communication is being stored comprising:
(a) analyzing the electronic communication to determine one or more designated groups of users;
(b) storing a copy of the electronic communication onto a storage device, wherein the stored copy is available to the one or more designated groups of users; and
(c) automatically analyzing the electronic communication to identify one or both of one or more participant and one or more contributor; and
(d) automatically notifying the one or both of one or more identified participant and one or more identified contributor that a copy of the electronic communication is being stored.

15. The method of claim 14, wherein the notification is an electronic communication to the one or both of one or more participant and one or more contributor.

16. The method of claim 14, wherein the stored copy includes content retrieved from one or more links embedded in the electronic communication.

17. The method of claim 14, wherein the stored copy includes one or more files attached to the electronic communication.

18. The method of claim 14, wherein the notification further comprises allowing one or both of one or more identified participant and one or more identified contributor to access a list of the one or more designated groups of users that can access the stored copy of the electronic communication.

19. The method of claim 14, wherein one or both of one or more identified participant and one or more identified contributor can modify one or both the one or more designated groups of users and content of the stored copy of the electronic communication.

20. The method of claim 14, wherein one or both of one or more identified participant and one or more identified contributor can delete the stored copy of the electronic communication.

21. The method of claim 14, wherein the notification further comprises allowing one or both of one or more identified participant and one or more identified contributor to access a list of one or more previously stored electronic communication in which the one or both of one or more identified participant and one or more identified contributor was also a participant or contributor.

22. The method of claim 14, wherein the notification allows one or both of one or more identified participant and one or more identified contributor to modify one or both one or more identified designated groups of users and content of one or more previously stored electronic communication in which the one or both of one or more identified participant and one or more identified contributor was also a participant or contributor.

23. The method of claim 14, wherein the notification allows one or both of one or more identified participant and one or more identified contributor to delete content of one or more previously stored electronic communication in which the one or both of one or more identified participant and one or more identified contributor was also a participant or contributor.

24. The method of claim 14, wherein the notification further comprises allowing one or both of one or more identified participant and one or more identified contributor to access a list of one or more previously stored electronic communication which are retrieved with a content search based on content of the electronic communication.

25. A system or apparatus for storing an electronic communication and notifying one or both of one or more identified participant and one or more identified contributor of the electronic communication of the storage comprising:
a) one or more processors capable of specifying one or more sets of parameters; capable of transferring the one or more sets of parameters to a source code; capable of compiling the source code into a series of tasks for automatically sending a notification and storing the electronic communication; and
b) a machine readable medium including operations stored thereon that when processed by one or more processors cause a system to perform the steps of specifying one or more sets of parameters; transferring one or more sets of parameters to a source code; compiling the source code into a series of tasks for automatically sending a notification and storing the electronic communication.
